(19) United States
(12) Patent Application Publication
(10) Pub. No.: US 2013/0148484 A1
(43) Pub. Date: Jun. 13, 2013

(54) DIAL FOOT OF A TIMEPIECE

(71) Applicants: Frederic Jeanrenaud, La Chaux-de-fonds (CH); Yves Winkler, Schmitten (CH)

(72) Inventors: Frederic Jeanrenaud, La Chaux-de-fonds (CH); Yves Winkler, Schmitten (CH)

(73) Assignee: THE SWATCH GROUP RESEARCH AND DEVELOPMENT LTD, MARIN (CH)

(21) Appl. No.: 13/704,075

(22) PCT Filed: Jun. 21, 2011
(86) PCT No.: PCT/EP11/60285

§ 371 Date: Feb. 27, 2013

(30) Foreign Application Priority Data
Jun. 22, 2010 (EP) 10166916.6

(51) Int. Cl. G04B 19/12

(52) U.S. Cl. CPC G04B 19/12
USPC 368/232

(57) ABSTRACT

A dial of a timepiece. The dial includes at least one foot. The foot is fixed on the dial and is used to fix the dial on the timepiece. The foot is produced in a metallic alloy which is at least partially amorphous.

The present invention relates to a dial foot of a timepiece, said one foot being fixed on said dial and used for fixing said dial on the timepiece.

The technical field of the invention is the technical field of precision engineering.

### TECHNOLOGICAL BACKGROUND

It is known that timepieces comprise a movement on which a dial is fixed. This dial comprises feet which are used, on the one hand, as a geometric reference in the production sequence of the dial and, on the other hand, for fixing said dial to the movement.

These feet are produced in crystalline metal such as steel, brass or gold. These feet are assembled by spot welding. They very often have a smaller diameter in the contact zone with the base of the dial, for three main reasons. Firstly, this makes it possible to avoid a welding overflow preventing the dial being placed correctly against the movement. Secondly, this makes it possible to ensure, in the case of impact on the foot, that the plastic deformation is localised in this narrow zone. The foot can then be adjusted whilst keeping good precision on the zone of a large diameter which will be adjusted on the movement. Finally, this smaller foot diameter in the contact zone with the base of the dial serves to avoid deformation of the base of the dial in the case of impact on a foot via intentional and controlled weakening of said foot.

However the problems of current feet are linked to mechanical properties which are characteristic of crystalline metals, i.e. very limited elastic deformation. In fact, each material is characterised by its Young's modulus E, equally termed modulus of elasticity (expressed generally in GPa), which characterises its resistance to deformation. Every material is also characterised by its elastic limit σₑ (expressed generally in GPa) which represents the stress beyond which the material is deformed plastically. It is therefore possible, for given dimensions, to compare the materials by establishing for each one the ratio of their elastic limit over their Young's modulus σₑ/E, said ratio being representative of the elastic deformation of each material. Thus, the greater this ratio, the greater is the elastic deformation of the material. Typically, for an alloy of the Cu—Be type, the Young's modulus E is equal to 130 GPa and the limit of elasticity σₑ is equal to 1 GPa, which gives a ratio σₑ/E of the order of 0.007, i.e. low.

Consequently, during handling errors, if the deformation applied on the feet is too high, the resulting stress risks exceeding the elastic limit of the alloy and consequently causing permanent plastic deformation. Given that said feet are often used as geometric reference in the production sequence of the dial, it is therefore necessary to unfold the feet in order to reposition them. Rupture of said foot can then occur if the stress is too high or by fatigue if the stresses occur in succession.

### SUMMARY OF THE INVENTION

The object of the invention is to reduce the difficulties of prior art by proposing to provide a dial foot in metal which has better resistance to impacts.

For this purpose, the invention relates to a timepiece dial comprising at least one foot. Said at least one foot is fixed on said dial and is used to fix said dial on said timepiece. Said at least one foot and the dial are produced in a metallic alloy which is at least partially amorphous.

A first advantage of the present invention is of making it possible for the dial feet to withstand impacts better. In fact, amorphous metals have elastic properties of greater interest. The elastic limit σₑ is increased which makes it possible to increase the ratio σₑ/E so that the material sees an increase in the stress beyond which it does not resume its initial shape. If the foot is deformed plastically with more difficulty, it is no longer necessary to unfold the foot in order to return it to its initial position. If the foot is more resistant, it is likewise weakened less by successive folding and unfolding and thus the foot has a longer lifespan.

Another advantage of the present invention is of making it possible to produce feet with smaller dimensions. In fact, as the amorphous metal is capable of withstanding greater stresses before being deformed plastically, it is possible to produce dial feet with smaller dimensions without forfeiting strength.

The present invention likewise relates to a timepiece dial comprising at least one foot, said dial is fixed on a support on which said at least one foot is fixed in order to fix said dial on said timepiece. Said at least one foot and the support are produced in a metallic alloy which is at least partially amorphous.

Advantageous embodiments of this dial are the subject of the dependent claims.

In a first advantageous embodiment, said at least one foot and the dial are simply one and the same part.

In a second advantageous embodiment, said at least one foot and the support are simply one and the same part.

In a third advantageous embodiment, said at least one foot is mounted on the dial.

In a fourth advantageous embodiment, said at least one foot is mounted on the support.

In another advantageous embodiment, said material is totally amorphous.

In another advantageous embodiment, the dial comprises at least one recess in which said at least one foot is fixed.

In another advantageous embodiment, the support on which the dial is fixed comprises at least one recess in which said at least one foot is fixed.

In another advantageous embodiment, the sides of said at least one recess comprise reliefs in order to improve the fixing of said at least one foot in said at least one recess.

In another advantageous embodiment, the reliefs disposed on the sides of said at least one recess form an internal screw thread.

In another advantageous embodiment, said at least one recess has a constant section.

In another advantageous embodiment, the base of said at least one recess has the largest section.

In another advantageous embodiment, the section increases linearly when approaching the base of said at least one recess.

In another advantageous embodiment, said foot has, in its contact zone with the dial or the support, a smaller diameter.

In another advantageous embodiment, said foot has, in its contact zone with the dial or the support, a smaller diameter and in the zone adjacent to this contact zone, an even smaller diameter.

In another advantageous embodiment, said at least one metallic element is a precious metal or an alloy based on such a precious material, said precious material being chosen from the group formed by gold, platinum, palladium, rhenium, ruthenium, rhodium, silver, iridium or osmium.

One of the advantages of these embodiments is of making it possible to produce the feet directly with the dial in the case where the feet and the dial form only a single part. In fact, the amorphous metal is very easy to shape and allows production of parts with complicated shapes with greater precision. This is due to the particular characteristics of amorphous metal which can soften whilst remaining amorphous for a certain time within a given temperature interval [T_{g}-Tₓ] which is characteristic of each alloy. It is thus possible to shape it with relatively low stress and at a fairly low temperature which makes it possible then to use a simplified process such as hot-forming whilst reproducing fine geometries very precisely because the viscosity of the alloy reduces greatly as a function of the temperature within said temperature interval [T₉-Tₓ]. Consequently it becomes possible to produce the dial and the feet in a single part and in a precise manner.

### BRIEF DESCRIPTION OF THE FIGURES

The objects, advantages and features of the dial foot according to the present invention will appear more clearly in the following detailed description of at least one embodiment of the invention, given solely by way of non-limiting example and illustrated by the appended drawings, in which:

FIG. 1 represents schematically a first embodiment of the invention;

FIGS. 2 and 3 represent schematically sectional views of dials fixed on their movement;

FIG. 4 represents schematically a second embodiment of the invention;

FIGS. 5 to 7 represent schematically alternatives to the second embodiment of the invention, and

FIG. 8 represents schematically a third embodiment of the invention.

FIG. 9 represents schematically a particular variant of the first embodiment of the invention.

### DETAILED DESCRIPTION

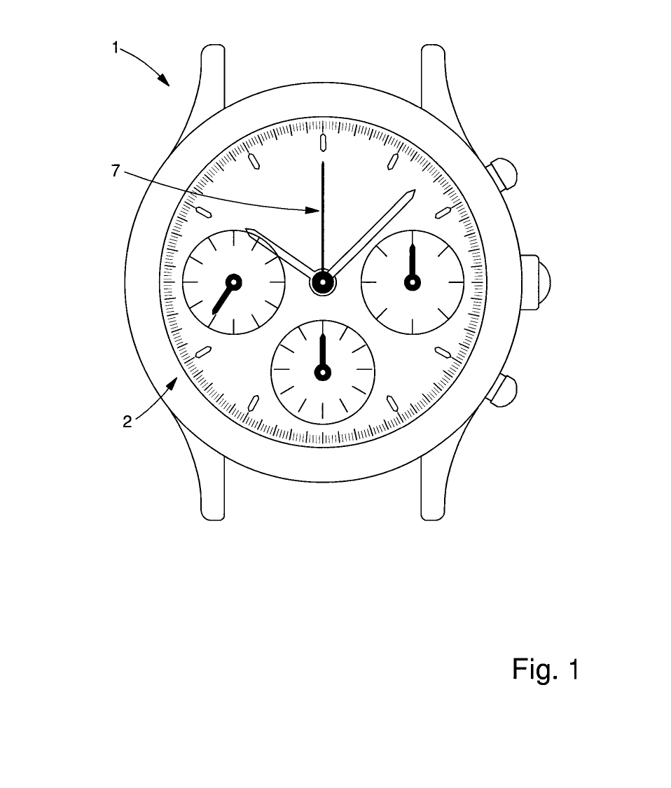

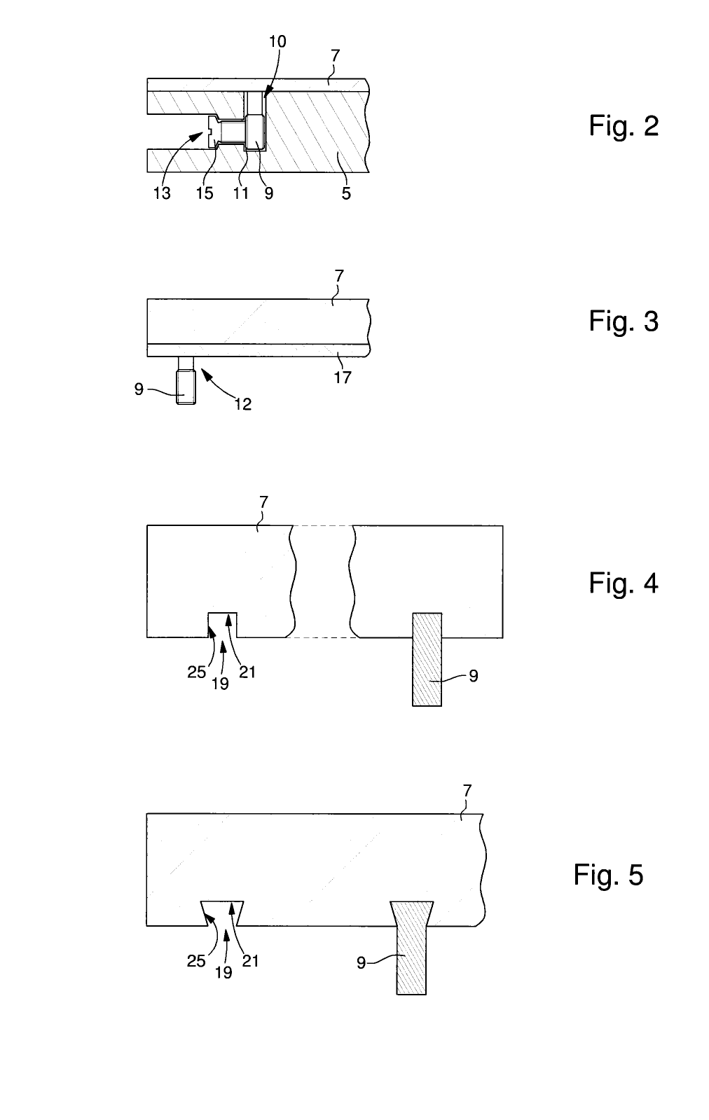

A timepiece 1 comprising a case 2 is represented in FIG. 1. In this case 2, there is provided, as can be seen in FIG. 2, a movement 5 on which a dial 7 is fixed. This dial 7 is fixed on the movement 5 by means of feet 9 which are fixed on said dial 7 and engage in the openings 11 of the movement 5. Fixing of the dial 7 on the movement 5 is ensured by fixing means 13. These fixing means 13 consist for example of a screw 15 which is engaged in a threaded hole which is transverse to the opening 11 and opens into the latter. This screw therefore screws said foot 9 so as to keep it fixed in the opening 11. Of course, it can be understood that, according to a variant represented in FIG. 3, the dial 7 is mounted on a support 17 on which the feet 9 are fixed as is the case for a dial 7 made of enamel cemented on a support 17 made of brass.

Advantageously, the feet 9 are produced in a material which is amorphous or at least partially amorphous. In particular, a material comprising at least one metallic element is used. For preference, the material will be an amorphous metallic alloy. There will be understood by a material which is at least partially amorphous that the material is able to solidify at least partially in the amorphous phase, i.e. it is able to lose all its crystalline structure at least locally.

In fact, the advantage of these amorphous metallic alloys arises from the fact that, during production thereof, the atoms making up these amorphous materials are not arranged according to a particular structure as is the case for crystalline materials. Therefore, even if the Young's modulus E of a crystalline metal and of an amorphous metal is identical, the elastic limit σₑ is different. An amorphous metal therefore differs by an elastic limit σₑ which is higher than that of the crystalline metal by a factor of approx. two to three. This makes it possible for amorphous metals to be able to undergo greater stress before reaching the elastic limit σₑ. Amorphous metals are deformed plastically with more difficulty and break in a brittle manner when the stress applied exceeds the elastic limit. Surprisingly, precious amorphous metals have good mechanical characteristics. The metallic element of said material can therefore comprise gold, platinum, palladium, rhenium, ruthenium, rhodium, silver, iridium or osmium.

Such feet 9 have the advantage of having greater strength and a longer lifespan relative to their equivalents made of crystalline metal.

In fact, as the amorphous metal has a higher elastic limit, it is necessary to apply greater stress in order to deform it plastically. For this reason, a foot 9 made of amorphous metal has greater resistance to stresses which are applied to it during an impact because it will be deformed elastically over a greater stress interval and revert to its initial position once the impact is over. As this stress interval in which the foot 9 is deformed elastically is greater for a foot 9 made of amorphous metal than for its equivalent made of crystalline metal, it makes it possible for said foot 9 made of amorphous metal to withstand stresses which would plastically deform said foot 9 made of crystalline metal. Since the deformation is elastic, these feet 9 no longer need to be unfolded to return them to their initial position and therefore they are weakened less which thus improves their lifespan.

Furthermore, as the elastic limit of an amorphous metal is greater than that of a crystalline metal by a factor of approx. two to three, which makes it possible to withstand greater stresses, it is conceivable to reduce the dimensions of said foot 9. In fact, as a foot 9 of a dial 7 made of amorphous metal can withstand greater stress without being deformed plastically, it is therefore possible, with an equivalent stress, to reduce the dimensions of the foot 9 relative to a crystalline metal. As the feet 9 are inserted into the openings 11 of the movement 5, the fact that the dimensions of the feet 9 are reduced makes it possible to reduce the dimensions of the openings 11.

However, reducing the size of the feet 9 increases the risk of deformation of the dial 7, especially if the foot 9 has a smaller diameter in the contact zone 10, 12 with the base of the dial 7 or of the support 17. According to a particular variant, the foot 9 has an even smaller diameter in the zone 14 adjacent to the contact zone 10, 12, as can be seen in FIG. 9. This makes it possible to separate the functions. The contact zone 10, 12 is used in order to avoid the welding overflow preventing correct placement of the dial 7 on the movement 5. The zone 14 is used to weaken the foot 9 so that it is deformed, elastically or plastically, at the level of this zone 14.

In order to produce and fix these feet 9 on the dial 7, several methods are conceivable.

In a first embodiment, it is conceivable to produce the feet 9 then to fix them on the dial 7. The feet 9 can be produced by machining but it is possible to produce them using the properties of amorphous metals. In fact, amorphous metal is very easily shaped which makes it possible to produce the parts with complicated shapes with greater precision. This is due to the particular characteristics of the amorphous metal which can soften whilst remaining amorphous for a certain time within a given temperature interval [T_{g}-Tₓ] which is characteristic of each alloy (for example for an alloy Zr_{41.24}Ti_{13.77}Cu_{12.7}Ni₁₀Be_{22.7}, T_{g}=350° C. and Tₓ=460° C.). It is thus possible to shape them under relatively low stress and at a fairly low temperature which makes it possible then to use a simplified process such as hot-forming. Use of such a material makes it possible furthermore to reproduce fine geometries very precisely because the viscosity of the alloy greatly reduces as a function of the temperature in the temperature interval [T_{g}-Tₓ] and the alloy therefore adopts all the details of the negative. For example, for a material based on platinum, shaping takes place at approx. 300° C. for a viscosity reaching 10³ Pa·s for a stress of 1 MPa, instead of a viscosity of 10¹² Pa·s at the temperature T_{g}.

One process which is used is hot-forming of an amorphous preform. This preform is obtained by melting, in a furnace, metallic elements forming the amorphous alloy. This melting is achieved under a controlled atmosphere with the aim of obtaining contamination of the alloy with oxygen which is as low as possible. Once these elements are molten, they are cast in the form of a semi-finished product, for example as a cylinder with dimensions near to those of the feet 9 of the dial 7, then cooled rapidly in order to preserve the at least partially amorphous state or phase. Once the preform is obtained, hot-forming is effected with the aim of obtaining an ultimate part. This hot-forming is produced by pressing within a range of temperatures between the vitreous transition temperature T_{g} of the amorphous material and the crystallisation temperature Tₓ of said amorphous material during a time determined for preserving a totally or partially amorphous structure. The aim is therefore to preserve the elastic properties which are characteristic of amorphous metals. The various steps for ultimate shaping of the foot 9 of the dial 7 are therefore:

a) heating matrices having the negative shape of the foot 9 up to a chosen temperature,
b) introduction of the preform made of amorphous metal between the hot matrices,
c) application of a closing force on the matrices in order to copy the geometry of the latter onto the preform made of amorphous metal,
d) waiting for a chosen maximum time,
e) opening of the matrices,
f) rapid cooling of the foot 9 below T_{g} so that the material keeps its at least partially amorphous phase, and
g) removal of the foot 9 from the matrices.

According to a variant of this first embodiment, a casting process is used. This process consists of casting the alloy which is obtained by melting the metallic elements in a mould which has the shape of the ultimate part. Once the mould is filled, the latter is cooled rapidly down to a temperature lower than T_{g} in order to avoid crystallisation of the alloy and thus to obtain a foot 9 made of amorphous or partially amorphous metal. The advantage of casting an amorphous metal relative to casting a crystalline metal is of being more precise. The solidification shrinkage is very low for an amorphous metal, less than 1% relative to that of crystalline metals which is from 5 to 7%.

After producing said feet 9, the latter are fixed to said dial 7 by welding. For preference, said feet 9 are designed as the feet 9 according to prior art, i.e. having a smaller diameter in the contact zone 12 with the base of the dial 7 in order to avoid the welding overflow preventing the dial 7 being placed correctly on the movement 5. Thus, in the case of impact on the foot 9, the plastic deformation is localised in this narrow zone in order to preserve the dial 7. Nevertheless, it is likewise possible to drive these feet 9, produced by hot-forming or by casting, into recesses 19 produced in advance on the dial 7. Of course, in the case where the dial 7 is mounted on a support 17, the feet 9 will be welded to the support or driven into recesses 19 cut on the support 17.

According to a second embodiment, which can be seen in FIG. 4, it is provided to duplicate-mould the feet 9 directly at the level of the dial 7 during production of said feet 9. For that, the technique of hot-forming is used. The process begins by producing recesses 19 on the dial 7 at the places where said feet 9 are to be placed. These recesses 19 have a depth which does not exceed half the thickness of the dial 7 in order not to weaken said dial 7 too much. Then the dial 7 is placed between the matrices and the previously described steps a) to g) are implemented so that the amorphous metal is duplicate-moulded directly in the recesses 19 and said feet 9 are formed. Retaining the feet 9 on the dial 7 is ensured by the sides 25 of the recesses 19 when said recesses 19 have a constant section. Friction between these sides 25 and the amorphous metal therefore prevent the feet 9 from becoming detached.

In order to improve retention of the feet 9 in the recesses 19, retaining means 23 are provided. These retaining means 23 can adopt various forms.

In a first alternative which can be seen in FIG. 5, these retaining means 23 can be the sides 25 of recesses 19 which are designed to have a non-constant section. For preference, the section at the base 21 of the recess 19 is greater than that at the level of the surface of the dial 7. It can likewise be provided that the section increases constantly when it approaches the base 21 of the recess 19. This design of the section of the recesses 19 in which the feet 9 are fixed makes it possible to retain said feet 9 naturally in said recesses 19 without requiring welding or cementing.

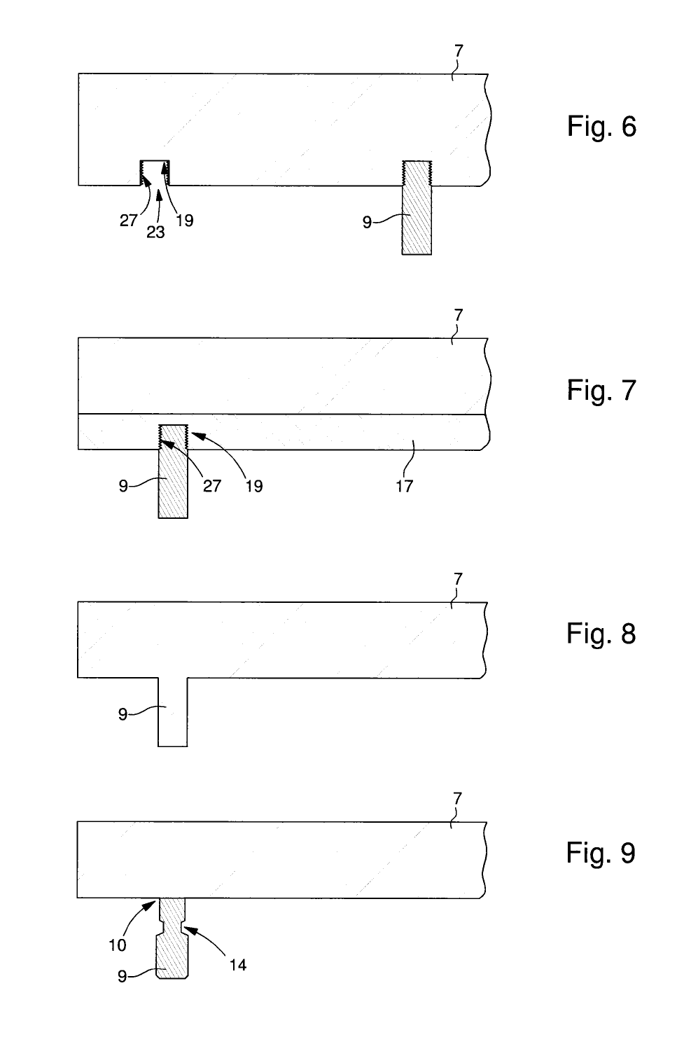

In a second alternative which can be seen in FIG. 6, it can be provided that the sides 25 of the recesses 19 comprise reliefs 27. These reliefs 27 can have the shape of hollows and/or of projections provided on the sides 25 of each recess 19. These hollows and/or projections can be designed so as to form an internal screw thread which allows the feet 9 to be screwed on and unscrewed. These reliefs 27 make use of the characteristics of amorphous metal to be able to soften whilst remaining amorphous within a given temperature interval [T_{g}-Tₓ] which is characteristic of each alloy, thus adopting all the details of the negative. The amorphous metal is then inserted in the hollows of the sides 25, thus ensuring better retention of the foot 9 in the recess 19. It will be understood that, in the case where the dial 7 is mounted on a support 17, the recesses 19 in which the feet 9 are produced and the sides 25 of which comprise reliefs 27 are produced on the support 17, as can be seen in FIG. 7.

A third embodiment which can be seen in FIG. 8 consists of producing the dial 7 and the feet 9 in one and the same part, i.e. the dial 7 and the feet 9 are produced in amorphous metal at the same time. For this, the matrices forming the mould form the complementary imprint of the part composed of dial 7 and feet 9. It will be understood that, in the case of a dial 7 mounted on a support 17, the support 17 and the feet 9 are simply one and the same part. This part is then cast or hot-formed in amorphous metal. The advantage is of having firstly perfect reproducibility of the process, since the dials 7 connected to their feet 9 are all produced in the same mould. Furthermore, this process has the advantage of being simple and not having a step of fixing the feet 9 with the risk of bending the feet 9 or of deforming the dial 7.

It can likewise be provided that the dial 7 and the feet 9 are produced in amorphous metal or at least partially amorphous metallic alloy but separately. There is understood by this that the feet 9 and dial 7 are separate parts and that the feet 9 are then mounted on the dial 7. This is also acceptable in the case where the dial 7 is fixed on a support 17 and the support 17 is made of amorphous metal. The feet 9 and the support 17 are different parts made of amorphous metal. The feet 9 are mounted on said support 17.

In the case where they are mounted on the dial 7 or on the support 17, the feet 9 are cemented or welded or fixed with any possible method.

It will be understood that various modifications and/or improvements and/or combinations evident to the person skilled in the art can be applied to various embodiments of the invention explained above without departing from the scope of the invention defined by the appended claims.

1-17. (canceled)

18. A timepiece dial comprising:
at least one foot, said at least one foot being fixed on said dial and used to fix said dial on said timepiece,
wherein said at least one foot and the dial are produced in a metallic alloy which is at least partially amorphous.

19. A timepiece dial comprising:
at least one foot, said dial is fixed on a support on which said at least one foot is fixed to fix said dial on said timepiece,
wherein said at least one foot and the support are produced in a metallic alloy which is at least partially amorphous.

20. The timepiece dial according to claim 18, wherein said at least one foot and the dial are one and a same part.

21. The timepiece dial according to claim 19, wherein said at least one foot and the support are one and a same part.

22. The timepiece dial according to claim 18, wherein said at least one foot is mounted on the dial.

23. The timepiece dial according to claim 19, wherein said at least one foot is mounted on the support.

24. The dial according to claim 18, wherein said material is totally amorphous.

25. The dial according to claim 19, wherein said material is totally amorphous.

26. The dial according to claim 18, wherein the dial comprises at least one recess in which said at least one foot is fixed.

27. The dial according to claim 19, wherein the support on which the dial is fixed comprises at least one recess in which said at least one foot is fixed.

28. The dial according to claim 26, wherein sides of said at least one recess comprise reliefs to improve fixing of said at least foot in said at least one recess.

29. The dial according to claim 27, wherein sides of said at least one recess comprise reliefs to improve fixing of said at least foot in said at least one recess.

30. The dial according to claim 28, wherein the reliefs disposed on the sides of said at least one recess form an internal screw thread.

31. The dial according to claim 29, wherein the reliefs disposed on the sides of said at least one recess form an internal screw thread.

32. The dial according to claim 26, wherein said at least one recess has a constant section.

33. The dial according to claim 27, wherein said at least one recess has a constant section.

34. The dial according to claim 26, wherein a base of said at least one recess has a largest section.

35. The dial according to claim 27, wherein a base of said at least one recess has a largest section.

36. The dial according to claim 34, wherein the section increases linearly when approaching the base of said at least one recess.

37. The dial according to claim 35, wherein the section increases linearly when approaching the base of said at least one recess.

38. The dial according to claim 18, wherein said foot has, in its contact zone with the dial or the support, a smaller diameter.

39. The dial according to claim 18, wherein said foot has, in its contact zone with the dial or the support, a smaller diameter and in a zone adjacent to this contact zone, an even smaller diameter.

40. The dial according to claim 18, wherein said metallic alloy comprises at least one metallic element which is a precious material or an alloy based on a precious material, said precious material being chosen from the group formed by gold, platinum, palladium, rhenium, ruthenium, rhodium, silver, iridium or osmium.
